(19) United States
(12) Patent Application Publication
(10) Pub. No.: US 2024/0359599 A1
(43) Pub. Date: Oct. 31, 2024

(54) PASSENGER SEAT FOR A TRANSPORT VEHICLE

(71) Applicant: LSEAT Engineering, Bruxelles (BE)

(72) Inventor: Yves HENDRICKX, Bruxelles (BE)

(73) Assignee: LSEAT Engineering, Bruxelles (BE)

(21) Appl. No.: 18/683,797

(22) PCT Filed: Aug. 16, 2022
(86) PCT No.: PCT/EP2022/072876

§ 371 Date: Feb. 15, 2024

(30) Foreign Application Priority Data
Aug. 16, 2021 (BE) 2021/5653

(51) Int. Cl. B60N 2/22

(52) U.S. Cl. CPC B60N 2/2209; B60N 2/2245

(57) ABSTRACT

Passenger seat for a transport vehicle, which seat comprises a vertical portion and a horizontal portion mounted on a support frame, which horizontal portion comprises a rear edge located at the edge of the vertical portion and a front edge located on the opposite side to that of the rear edge, which support frame delimits a free space underneath the horizontal portion, characterized in that the horizontal portion is mounted on a first moving mechanism arranged to enable the whole of the horizontal portion to be tilted such that the front edge descends relative to the vertical portion.

The present invention relates to a passenger seat for a transport vehicle, which seat comprises a vertical portion and a horizontal portion mounted on a support frame, which horizontal portion comprises a rear edge located at the edge of the vertical portion and a front edge located on the opposite side to that of the rear edge, which support frame delimits a free space under the horizontal portion, this seat being tiltable by means of a device which can be operated by the user and locked by a third party (e.g. a member of the crew).

A passenger seat is known from EP-A 0 723 890 and is used in public transport vehicles, such as aircraft, buses, trains, etc. The traveller sits on the horizontal portion and his/her back rests against the vertical portion. The latter is often tiltable over an angle of approximately 15°, thus enabling the passenger to relax a little. The seat known from EP-A 0 723 890 comprises a cushion which is mounted on a first moving mechanism arranged to enable a section of the cushion to tilt so that the front edge descends relative to the vertical portion. The fact that a section of the cushion can be tilted gives the traveller greater comfort, especially when he/she wants to relax.

The problem with the known passenger seat is that the guide rail, which guides the tilting, is housed in the armrests of the seat. Such an arrangement of the rail is not suitable, in particular for an aircraft seat, because it does not provide sufficient resistance to impacts or impact testing.

The problem with existing transport seats is that they are designed first and foremost to be sat on and offer very few options for tilting, thus limiting the comfort of the passenger when he or she wants to adopt a more relaxed position on the seat. Of course, the passenger may stretch his/her legs into the space under the passenger seat in the previous row, but since the horizontal portion remains fixed, the legs of the passenger are barely supported and the passenger is not in a comfortable position.

The purpose of the invention is to produce a passenger seat that offers greater passenger comfort while respecting the distance between rows of passenger seats in the vehicle and offering sufficient resistance in the event of an impact. The mechanism for the tiltable seat of the invention may be grafted into the structure of existing seats. Moreover, commercial use of this type of seat requires that the mechanism enabling the seat to tilt can be blocked (locked). It is more effective to incorporate the device into all the seats of the aircraft, or at least into a whole category of aircraft seats. On the other hand, the current business model of several airlines is based on a low price, accompanied by paid options including the present tiltable seat. Thus, the fact that the device can be easily locked or unlocked by a member of the crew is a huge commercial advantage: the passenger benefits from increased comfort, which is particularly useful for flights lasting several hours; the airline does not have fewer seats per aircraft and can obtain a substantial additional cost.

To this end, a passenger seat according to the invention is characterized in that the horizontal portion is mounted on a first moving mechanism arranged to enable the whole of the horizontal portion to be tilted such that the front edge descends relative to the vertical portion. Tilting the whole of the horizontal portion, will tilt it towards the floor of the vehicle without affecting the distance between the rows of passenger seats in the vehicle. Moreover, tilting the horizontal portion will form a downwards slope towards the space under the seat in the previous row, enabling the passenger to fully stretch out his/her legs, which will then be better supported by the horizontal portion of the seat, and to slide part of his/her legs under the seat in the previous row.

Thus, preferably, the vertical portion does not tilt any more than the usual seats. Typically, the tilt angle is less than 30° (e.g. 15°) or the tilt distance from the top is less than 25 centimetres.

Advantageously, according to one variant, the moving mechanism of the passenger seat according to the invention is also arranged to enable the rear edge to be raised relative to the vertical portion. This enables the horizontal portion to be tilted further, further increasing the comfort of the passenger.

Alternatively and preferably, the rear edge of the horizontal portion moves forwards relative to the vertical portion, which enables the front edge of the horizontal portion to tilt downwards more easily. According to another variant, which may be combined with the fact that the rear edge of the horizontal portion moves forwards relative to the vertical portion, the horizontal portion is coupled to a pair of ball joints which either each contain a torsion bar or are coupled to a system enabling rotation according to the desired tilt, such as a rotation bar or hinges.

One preferred option is that the bottom segment of the horizontal portion tilts forwards so as to avoid too great an angle in the tilted position.

Preferably, the passenger seat according to the invention is characterized in that the first mechanism comprises at least one first guide rail mounted on the support frame, which horizontal portion advantageously comprises a first lug which extends into the first guide rail. This makes the first moving mechanism of the seat simple, inexpensive and reliable.

Preferably, the first moving mechanism of the passenger seat according to the invention comprises a first and a second member mounted so that they can pivot relative to each other, the first member being mounted on the support frame and the second member being mounted on a lower surface of the horizontal portion. This offers a simple, reliable and cost-effective solution for the first moving mechanism.

The first moving mechanism is provided with a locking device to prevent a third party, including the passenger, from freely moving the horizontal portion. This locking device can, advantageously, be unlocked easily via a direct manual action, remotely or via computer means.

Advantageously, the same remote and/or computer means controls the locking and unlocking mechanism. This computer means is preferably a wireless communication system, such as via infra-red. Advantageously, this locking and unlocking means is connected to a screen that can be accessed by a member of the crew, such as a dashboard screen or a portable electronic means such as a tablet. Thus, a member of the crew can easily unlock the seats requested by passengers, whether before boarding, between boarding and take-off or even during flight. Moreover, this locking system prevents the passenger from putting the seat in the tilted position when safety conditions require an upright position.

Preferably, there is a double locking means: a first locking means is under the control of the crew and the second locking means is under the control of the passenger.

Preferably, the locking means under the control of the passenger only operates in the fully seated or lying position, so that any intermediate, partially tilted positions may be changed without constraint. However, changing from the vertical position to the tilted position only occurs when the passenger (and the member of the crew) has activated the unlocking means. The same applies to changing from the tilted position to the vertical position.

Preferably, the first member of the passenger seat according to the invention comprises a first concave ring having a first geometry, the second member comprising a second convex ring having a second geometry, said first and second geometries being complementary to each other. This ensures that the first moving mechanism is reliably attached.

Advantageously, the weight of the passenger causes the tilt, in particular for systems where the horizontal portion has been moved forwards relative to the vertical portion. When the horizontal portion is moved forwards, the fact that the passenger is sitting at the front of the seat causes a torsional force, the moment of which increases depending on where the passenger is sitting, a slimmer passenger and/or a child will sit further forwards, causing a sufficient torsional moment. Similarly, the passenger who would sit the furthest back on the seat will return it to the vertical position. This is preferable when the horizontal portion is coupled to a pair of ball joints comprising either a torsion bar or (and this is simpler) a system enabling rotation such as a rotation bar or hinges.

Alternatively, a spring and/or piston system at the rear of the horizontal portion enables and/or ensures its return to a non-tilted position.

Preferably, the passenger seat according to the invention comprises a flap which is mounted on a second moving mechanism arranged to enable the flap to be moved between a first storage position and a second position where the flap extends as a continuation of the front edge so as to support the lower legs of a passenger sitting on the seat. The presence of the flap and the fact that it is mounted on a second moving mechanism enables the horizontal portion of the passenger seat to be extended, so to speak, offering more comfort to the passenger by increasing leg support.

Advantageously, the first mechanism comprises a return spring arranged to return the horizontal portion to a rest position. This makes it easier to store the flap after use.

An advantageous variant of a passenger seat according to the invention is characterized in that the first moving mechanism comprises a first plate connected to the support frame so that it can slide relative to the support frame and thus perform a back-and-forth movement relative to the vertical portion. Using a first plate enables this first plate to be simply mounted on the existing seat structure. The back-and-forth movement enables the cushion of the seat to move forwards relative to the vertical portion and thus making the cushion easier to tilt.

The first plate may comprise a first and a second portion mounted together by a hinge to thus enable the first and second portions to pivot relative to each other during said tilting.

The invention will now be described in more detail using the drawings, which show embodiments of the passenger seat according to the invention. In the Drawings

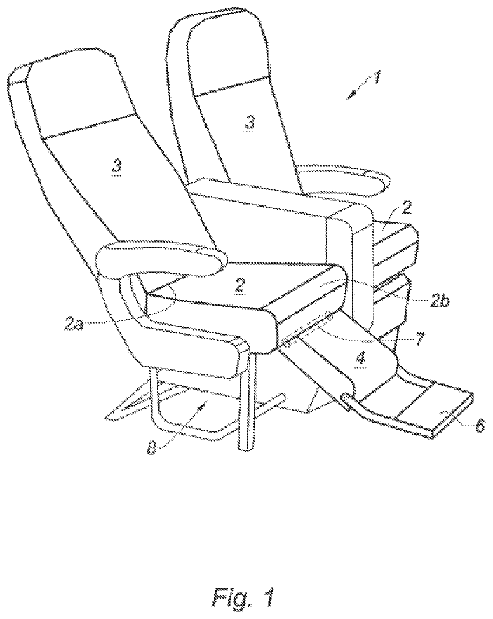

FIG. 1 shows a row of two commonly known passenger seats;

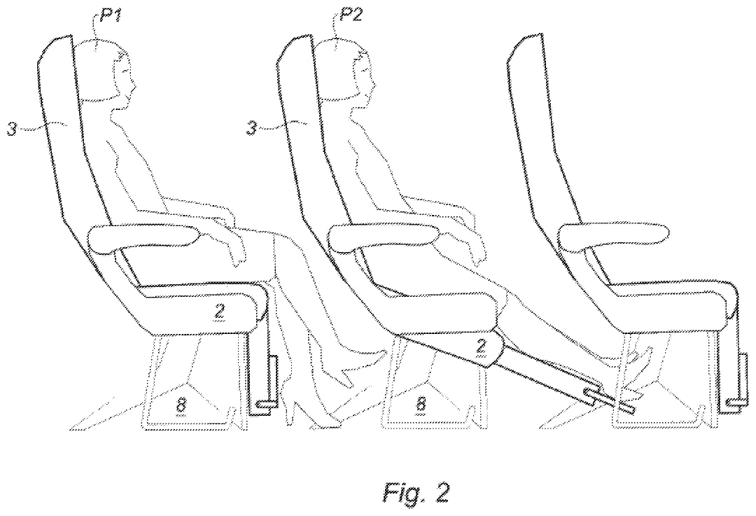

FIG. 2 shows a female passenger on an airliner sitting normally in her seat and another passenger sat in a passenger seat according to the invention;

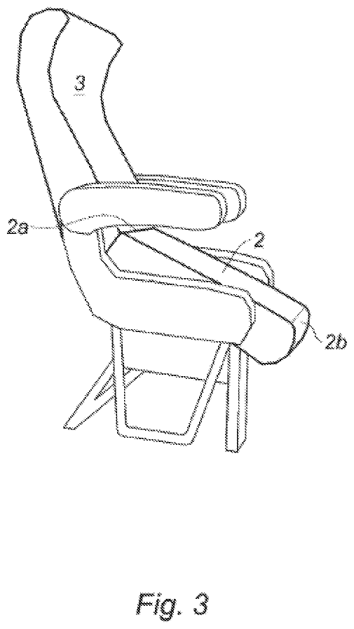

FIG. 3 shows a position that can be used in a passenger seat according to the invention;

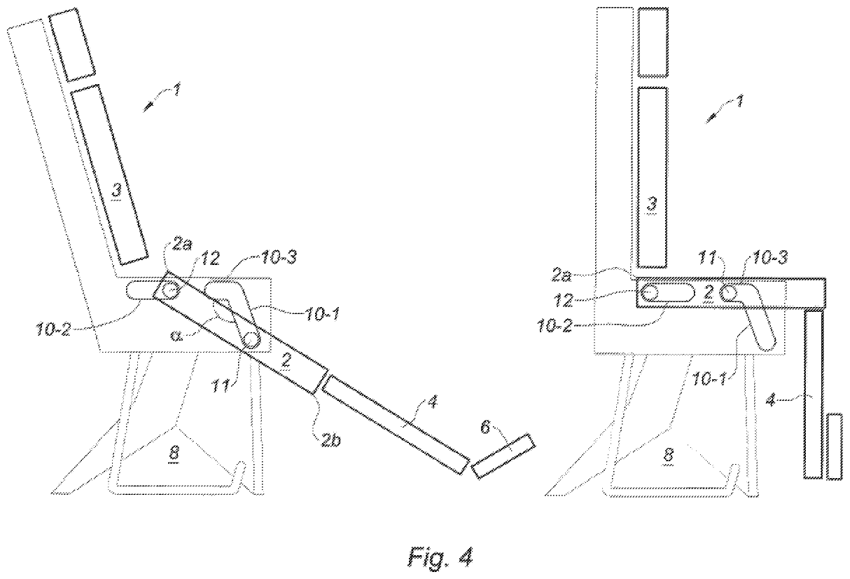

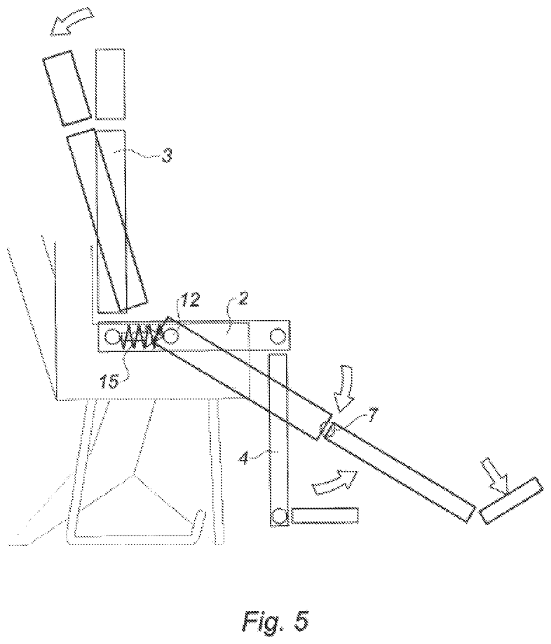

FIGS. 4 and 5 schematically show an embodiment of a passenger seat according to the invention;

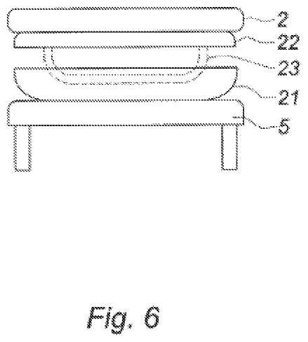

FIG. 6 shows an embodiment of a first moving mechanism according to the invention;

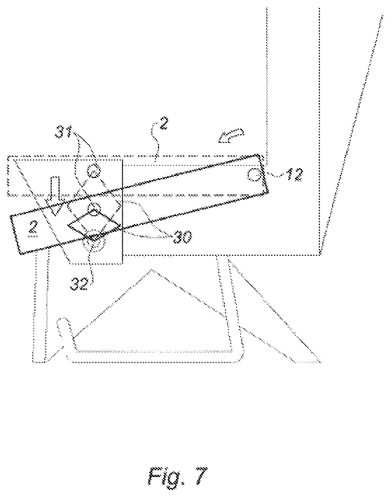

FIG. 7 shows another embodiment of a first moving mechanism according to the invention;

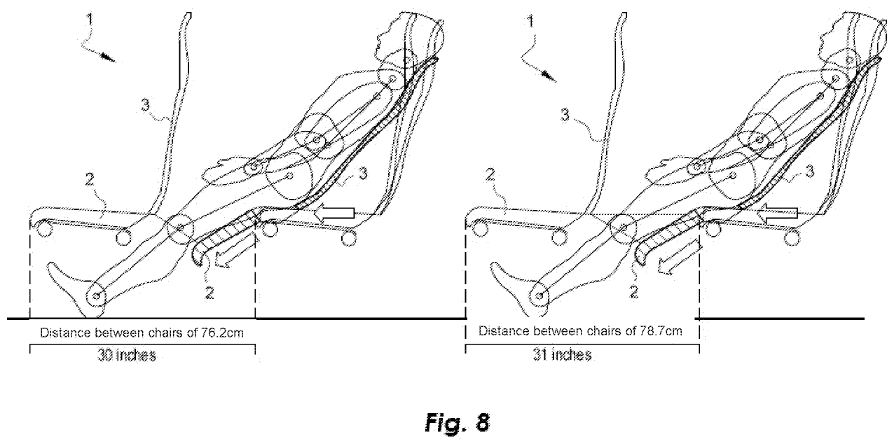

FIG. 8 shows a preferred version of the tilt mechanism;

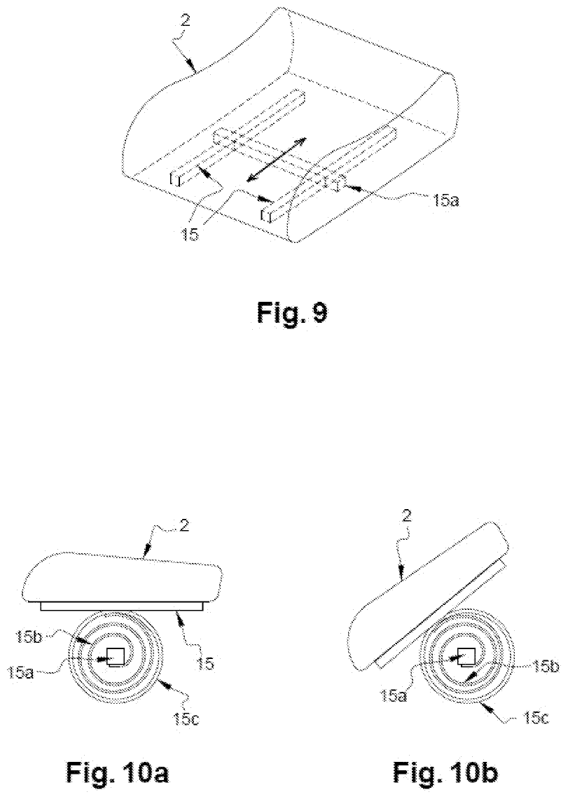

FIG. 9 shows a system enabling the horizontal portion to move forwards relative to the vertical portion;

FIG. 10 shows the arrangement of the horizontal portion with a ball joint comprising a torsion bar.

In the drawings, the same reference has been attributed to the same item or to a similar item.

FIG. 1 shows a row of two existing passenger seats 1 as used on an airliner for short and/or medium-haul flights. For clarity, the invention will be described using an example of an aircraft passenger seat. It goes without saying that the invention is not limited to aircraft seats and that it applies to other passenger seats, such as those used on buses, trains, boats or other public transport vehicles for people, in particular those where people are transported over distances that generally take more than one hour. However, the invention is particularly advantageous for aircraft seats, given that it offers a much more comfortable seat while respecting the strict regulatory and space constraints imposed. For example, the invention enables the existing structure of aircraft seats to be used, which offers the advantage of not having to undergo long and difficult approval procedures.

The known passenger seat 1 shown in FIG. 1 comprises a vertical portion 3 and a horizontal portion 2 mounted on a support frame 5. The horizontal portion 2 comprises a rear edge 2a located at the edge of the vertical portion 3 and a front edge 2b located on the opposite side to that of the rear edge. The support frame and the horizontal portion delimit a free space 8 under the horizontal portion. Higher category seats preferably also comprise a flap 4 which is mounted on a second moving mechanism 7 arranged to enable the flap to be moved between a first storage position, shown on the seat in the background of the figure, and a second position, shown on the front part of the figure, where the flap extends as a continuation of the front edge so as to support the lower legs of a passenger sitting on the seat. A footrest 6 may also be fitted to the passenger seat. The passenger seat is attached to the floor of the vehicle in which it is installed and cannot be moved from its position on the floor, because this could harm passengers in adjacent rows.

FIG. 2 shows a female passenger P1 on an airliner sitting normally in her passenger seat 1. The passenger is sitting on the horizontal portion 2 of the seat and her back is resting against the vertical portion 3, which may be slightly tilted, for example at an angle of between 5° and 15° relative to a vertical line extending from the floor. This range has to be limited so as not to disturb passengers in the next row. The free space 8 under the seat of the row before the one where the female passenger P1 is sitting may be used by the female passenger P1 to extend her legs. However, the seated position of the female passenger P1 does not allow her to stretch her legs comfortably. She could, of course, move forwards on the horizontal portion of the seat to slide her legs further under the seat in front, but she would lose a large part of the support offered by the seat and her legs would hardly be supported.

The passenger seat according to the present invention enables greater comfort for the passenger while respecting the distance between the rows of passenger seats in the vehicle. For this purpose, FIG. 2 shows another passenger P2 who is in a stretched position with part of her legs housed in the free space 8 of the seat in the previous row. It shows that the back, buttocks and a large part of the legs of the passenger P2 are supported by the seat on which she is sitting. This is made possible according to the invention by the fact that the horizontal portion 2 is mounted on a first moving mechanism arranged to enable the whole of the horizontal portion to be tilted such that the front edge descends relative to the vertical portion. Tilting the whole of the horizontal portion will tilt it towards the floor of the vehicle without thus affecting the distance between the rows of passenger seats in the vehicle. Moreover, tilting the horizontal portion will form a downwards slope towards the space under the seat in the previous row, thus enabling the passenger to fully stretch out his/her legs and to slide part of his/her legs under the seat in the previous row.

FIG. 3 shows a position that can be used in a passenger seat according to the invention. In this figure, the rear edge 2a of the horizontal portion is raised relative to the vertical portion 3 and the front edge 2b is lowered relative to the rest position of the vertical portion. Alternatively, only the front edge could be lowered and the rear edge could remain in place.

To enable the whole of the horizontal portion of the passenger seat according to the invention to be tilted, the passenger seat comprises a first moving mechanism arranged to enable the whole of the horizontal portion to be tilted such that the front edge descends relative to the vertical portion. FIG. 4 schematically shows an example of an embodiment of such a first moving mechanism. The latter comprises at least one first guide rail 10-1 mounted on the support frame and a first lug 11 which extends (penetrates) into the first guide rail and which, preferably, is mounted on the horizontal portion 2 of the seat. Applying the first guide rail to the support frame, which forms the actual chassis of the seat, means that the moving mechanism is integrated into the support frame. In the event of an impact, a force applied to the support mechanism will be distributed across the whole of the support frame. This makes is possible to manufacture a seat that withstands impact tests exerting a force greater than 10 g, in particular 16 g, as required by safety standards. The first lug 11 is mounted close to the front edge 2b of the horizontal portion 2, preferably substantially in the centre in the longitudinal direction of the passenger seat when only the front edge 2b is tiltable. Preferably, the first mechanism comprises two first guide rails and two first lugs in order to have one on both the right and left sides of the seat and thus facilitate balanced tilting of the seat. The first guide rail(s) preferably form(s) an angle of between 90° and 135°, more particularly between 90° and 110° relative to the lower surface of the horizontal portion. According to another embodiment, the first guide rail is mounted on the horizontal portion and the lug is mounted on the frame.

In the embodiment where both the rear edge 2a and the front edge 2b of the horizontal portion are moved, the first lug 11 and the first guide rail will be located at substantially half the length of the horizontal portion.

To prevent the horizontal portion from tilting independently of the passenger, the first moving mechanism is preferably provided with a blocking mechanism 13. The latter is achieved, for example, by a stopper applied in the first guide rail or by a pin which may engage in the first lug(s). The stopper then holds the first lug(s) in place to maintain the horizontal portion in an initial position where it extends substantially horizontally. Such a stopper is, for example, mounted on a first spring and controlled using a rod. The passenger then simply pulls on the rod to move the stopper and release the first lug(s) to enable the first lug(s) to move in the first guide rail. If a pin is used, the passenger simply releases the pin from the lug in which it is housed, also using a rod. Preferably, this blocking mechanism can be locked as described above (for example, by a member of the crew) so as to prevent a third party, including the passenger, from freely moving the horizontal portion.

The movement of the first lug(s) 11 in the first guide rail 10-1 will cause the horizontal portion 2, to which the first lug(s) are attached, to move downwards and tilt towards the floor. The length of the first guide rail 10-1 and the angle a at which the first guide rail 10-1 is tilted will determine the tilt that can be imposed on the horizontal portion of the seat.

When the passenger seat is of the type where the rear edge 2a of the horizontal portion is housed under the vertical portion 3, as shown in FIG. 4, the first moving mechanism will preferably be provided with at least two additional first guide rails 10-2 and 10-3. An additional first lug 12 will be housed in the additional first guide rail 10-2. The additional first lug 12 will be housed close to the rear edge 2a of the horizontal portion and will extend into one of the additional first guide rails 10-2. The latter will be applied horizontally at the bottom on the lateral flanks of the seat. The other of the additional first guide rails 10-3 will be applied so that it forms an assembly with the first guide rail 10-1. The angle between the additional first guide rail 10-3 and the first guide rail will have a value that is equal to that of the angle a. Similar to that described for the first guide rail 10-1, the additional guide rails 10-2 and 10-3 can be mounted on both the right and left sides of the seat.

Therefore, in the latter embodiment, to place the seat in the downwards tilted position, the passenger will first impart a horizontal translation movement to the horizontal portion of the seat to enable it to disengage from the vertical portion 3. The horizontal portion will then move horizontally because the additional first lug 12 will slide in one of the additional first guide rails 10-2 and the first lug 11 will slide in the additional first guide rail 10-3. When it reaches the junction between the other of the additional first guide rails 10-3 and the first guide rail 10-1, the first lug will leave the other of the additional first guide rails 10-3 to join the first guide rail 10-1 and follow the route similar to that described above.

Still referring to FIG. 4, an advantageous variant is proposed when the passenger seat is of the type where the rear edge 2a is housed under the vertical portion 3 and where the internal structure of the member 2a is separated from the member 3, but where the covering still joins the member 3 via an expandable part, the first guide rail will preferably be composed of at least two sections 10-2 and 10-3. In the first section 10-2 of the guide rail, an additional first lug will be housed close to the rear edge 2a of the horizontal portion and will extend into the first section 10-2 of the guide rail. The latter will preferably be applied horizontally to the rear portion of the horizontal portion. The second section 10-3 of the first guide rail will be applied to the front portion of the horizontal portion. The second section 10-3 has two portions which form an angle with each other having a value equal to that of the angle a of between 90° and 135°, more particularly between 90° and 110°. Similar to that described for the first guide rail 10-1, the first and second sections of the guide rails 10-2 and 10-3 can be mounted on both the right and left sides of the seat.

In most aircraft seats, the support frame comprises two bars, a front bar and a rear bar, arranged parallel to each other and extending in a transverse direction of the seat. These bars are mounted in the horizontal portion under the covering cushion. The first guide rail will then be arranged so that the tilted section, in particular the second section 10-3, is arranged in front of the front bar to thus ensure that the tilt of the horizontal portion 2 is not affected by the front bar.

When the passenger seat is provided with a flap 4, and where appropriate a footrest 6, it is preferable that the flap can also be moved to extend as a continuation of the horizontal portion when the latter is in a tilted position. For this purpose, the flap is mounted on a second moving mechanism 7 arranged to enable the flap to be moved between a first storage position, shown on the right in FIG. 4, and a second position, shown on the left in the same FIG. 4, where the flap extends as a continuation of the front edge 2b so as to support the lower legs of a passenger sitting on the seat. The second moving mechanism 7 is preferably a self-locking ball joint arranged to pivot between two predetermined positions and be blocked in each of these positions. The first storage position corresponds to a position where the flap is located under the front edge 2b and forms an angle β of between 45° and 90° with the horizontal portion. Alternatively, the first storage position may correspond to a position where the flap is located under the horizontal portion of the seat. To move the flap to the second position, the passenger simply pivots the flap either by hand or by foot using the footrest 6 if the flap is provided with one. Using the self-locking ball joint makes it easy to pivot the flap between these two positions. Where appropriate, the flap may comprise a control lever to control its movement. This control lever may be formed by the footrest.

According to another embodiment not shown in the drawings, the second moving mechanism comprises a second guide rail and the flap comprises a second lug which extends into the second guide rail. It is also possible to provide small wheels under the flap to enable the flap to roll along the floor when it is moved from its storage position and its extended position.

Preferably, the first mechanism comprises a return spring 15 arranged to return the horizontal portion to a rest position, as shown in FIG. 5. The return spring will be attached to the frame of the seat on the one hand and to the horizontal portion 2 on the other, for example by using the additional first lug 12. When the passenger seat is in the rest position, the return spring will also be in the rest position, housed in the bottom of the seat. The return spring will be stretched when the seat is in the tilted position and will therefore be blocked in this position. Unblocking the return spring, for example using a rod, will release it and return the horizontal portion to the rest position.

FIG. 6 shows another embodiment of a first moving mechanism according to the invention. In this other embodiment, the first moving mechanism is formed by a ball joint composed of a first ring 21 and a second ring 22 mounted so that they can pivot relative to each other. The first ring is mounted on the support frame and the second ring is mounted on a lower surface of the horizontal portion. The first ring 21 comprises a concave surface 23 having a first geometry, the second ring comprising a convex surface 24 having a second geometry. Compression using a clamping screw ensures motion stiffness. The first and second geometries are complementary to each other. A friction layer 27 is housed between the rings.

The complementary geometry enables the second ring to be moved relative to the first ring. Since the latter is attached to the frame, the horizontal portion may be moved and may therefore be tilted downwards. The convex shape of the surface 24 which can move relative to the concave shape will enable a pivoting movement which will be transferred to the horizontal portion.

On the market for passenger seats for transport vehicles, there are seats where the horizontal portion is mounted by means of a connecting piece on a shaft which forms part of the support frame of the seat. FIG. 7 shows such a seat on which another embodiment of the first moving mechanism is mounted. Applying the first moving mechanism according to the invention to such a seat would mean that the first mechanism could form the connecting piece. The horizontal portion of the seat would be mounted on two hinge points 12 placed in the bottom of the seat close to the rear edge on the one hand and on the first mechanism on the other. For example, the latter would be formed by a piston or a scissor jack mechanism 30, enabling the horizontal portion to be lowered and raised. When this horizontal portion is lowered or raised, it pivots using the hinge points 12, thus enabling the horizontal portion to be tilted and placed back. The jack mechanism 30 is attached to the shaft 32 forming part of the support frame of the seat by a first attachment point and to the horizontal portion of the seat by a second attachment point 31. The movement of the scissor jack will then pivot the horizontal portion of the seat.

According to another embodiment, the first moving mechanism comprises a first plate connected to the support frame so that it can slide relative to the support frame and thus perform a back-and-forth movement relative to the vertical portion 3. The first plate may comprise a first and a second portion mounted together by a hinge to thus enable the first and second portions to pivot relative to each other during said tilting. The first guide rail 10-1 is mounted on the support frame, in particular on either side of lateral flanks of the first plate. The first plate can then slide along the first guide rail that supports it. The back-and-forth movement enables the first plate to slide towards the front of the seat, enabling the second portion thereof to partially extend beyond the front bar of the seat. Therefore, this second portion of the first plate extends beyond the front bar and may tilt downwards without being affected by the front bar. The second portion pivots relative to the first thanks to the hinge.

Preferably, the first plate is connected to the support frame by means of a return spring arranged to return the first plate to a rest position where the covering cushion extends substantially horizontally. This makes it easier to return the first plate to its rest position.

According to one variant, the first portion of the first plate is mounted such that, during back-and-forth movement, it remains substantially horizontal. The second portion of the first plate is mounted such that, during back-and-forth movement, it can pivot.

Preferably, the first moving mechanism comprises a second plate rigidly connected to the support frame, the first plate being mounted on the second plate. This enables existing seats to be used to mount the moving mechanism.

### A Simple Alternative is Shown in FIGS. 8-10

FIG. 8 shows the tiltable seat 1 in the upright position (on the left). The bottom of the vertical portion 3 is close to the rear edge of the horizontal portion 2. When the system is unlocked, the passenger may move the horizontal portion 2 forwards relative to the vertical portion 3, then tilt it so that the front edge of the horizontal portion descends relative to the vertical portion, simply by moving his/her weight onto the front edge of the horizontal portion 2, which enables the seat 1 to be tilted (right-hand part of FIG. 8). The vertical portion 3 remains substantially vertical, and/or only tilts slightly, so that it does not encroach, or only marginally encroaches, on the space of the next seat. For example, as shown in FIG. 8, the lowest segment of the vertical portion 3, or even the whole of the vertical portion 3, can tilt forwards, in other words the bottom of the vertical portion 3 is moved forwards, which enables the seat in the tilted position to be relatively flat, without encroaching on the space of the next passenger (e.g. not more than 20 cm, preferably not more than 15 cm). Moreover, in this way, the space between the horizontal 2 and vertical 3 portions remains limited and compatible with optimal passenger comfort. Thus, according to an advantageous alternative, the bottom of the vertical portion 3 is tilted for this purpose, and the space between the rear edge of the horizontal portion 2 and the bottom of the vertical portion 3 is reduced, even in the tilted position. According to another advantageous alternative, the horizontal portions 2 and 3 are covered by a cover with an expandable texture, so that moving the horizontal portion 2, tilting it or even tilting the vertical portion 3 does not create empty spaces under the passenger and does not cause tears in the cover.

A preferred system under the horizontal portion 2 is shown in FIG. 9: two rails 15 are attached to a surface of a plate and the other surface of the plate is attached to the horizontal portion 2. A slat 15a connects the two rails 15 and can slide along these two rails, enabling the horizontal portion 2 to move forwards relative to the vertical portion 3 and relative to the frame 5 of the seat. Each of the two ends of this slat 15a is associated with a rotation device 15b, in this case a ball joint, which is connected to a torsion bar 15c. The rotation device 15b, rather than a ball joint connected to a torsion bar 15c, may have been one or more (e.g. 2) hinge(s) or a pair of rotation bars. When the passenger moves the horizontal portion 2 forwards, it slides on the rails 15 (if the device is unlocked). Next, when the passenger moves his/her weight towards the front of the horizontal portion 2, a torsional moment causes the horizontal portion 2 to tilt, which is made possible by the rotation device 15b. The rotation device 15b is attached to the frame 5 of the seat, for example by means of a rigid plate, which enables the tiltable seat 1 to be firmly anchored to the support frame 5, a necessity for seats in a means (vehicle) of transport, in particular when the means of transport is at high speed, as in the case of an aircraft. When the horizontal portion 2 is fully tilted, the position may be reversibly locked. Returning to the initial non-tilted position is achieved in the reverse way: optionally unlocking, placing the weight of the passenger at the rear of the horizontal portion 2 and repositioning the horizontal portion 2 so that the rear edge of the horizontal portion 2 is close to the vertical portion 3.

1. A passenger seat for a transport vehicle, which seat comprises a vertical portion and a horizontal portion mounted on a support frame, which horizontal portion comprises a rear edge located at the edge of the vertical portion and a front edge located on the opposite side to that of the rear edge, which support frame delimits a free space under the horizontal portion, wherein the horizontal portion is mounted on a first moving mechanism arranged to enable the whole of the horizontal portion to be tilted such that the front edge descends relative to the vertical portion, wherein said first moving mechanism comprises a locking device to prevent unwanted movement of said horizontal portion.

2. The passenger seat according to claim 1, wherein the first moving mechanism comprises rails and/or a slat, said slat comprising a device enabling said horizontal portion to be tilted, said rails and/or said slat enabling said horizontal portion to be moved forwards relative to the vertical portion and/or relative to the support frame, and then the whole of said horizontal portion to be tilted.

3. The passenger seat according to claim 2, wherein the device enabling the whole of the horizontal portion to be tilted comprises a pair of rotation bars, several hinges or a pair of ball joints.

4. The passenger seat according to claim 1, wherein in the tilted position, the bottom of the vertical portion is moved forwards and/or wherein the top of the vertical portion does not encroach more than 20 cm on the space of the next passenger.

5. The passenger seat according to claim 1, wherein the locking device can be unlocked via direct manual action, remotely, and/or via computer means.

6. Passenger seat according to claim 1, wherein it comprises at least one first guide rail mounted on the support frame, which horizontal portion comprises a first lug which extends into the first guide rail; wherein the first guide rail extends with an angle of between 90° and 135° relative to a lower surface of the horizontal portion.

7. (canceled)

8. The passenger seat according to claim 1, characterized in that, in the tilted position, the rear edge of the horizontal portion is moved forwards relative to the vertical portion.

9. The passenger seat according to claim 1, wherein the first moving mechanism comprises a first and a second member mounted so that they are able to pivot relative to each other, the first member being mounted on the support frame and the second member being mounted on a lower surface of the horizontal portion.

10. Passenger seat according to claim 9, wherein the first member comprises a first concave ring having a first geometry, the second member comprising a second convex ring having a second geometry, said first and second geometries being complementary to each other; wherein a friction layer is housed in the first member.

11. (canceled)

12. The passenger seat according to claim 1, wherein it comprises a flap which is mounted on a second moving mechanism arranged to enable the flap to be moved between a first storage position and a second position where the flap extends as a continuation of the front edge so as to support the lower legs of a passenger sitting on the seat.

13. The passenger seat according to claim 12, wherein the first storage position corresponds to a position where the flap is located under the horizontal portion of the seat.

14. The passenger seat according to claim 12, wherein the first storage position corresponds to a position where the flap is located under the front edge and forms an angle of between 45° and 90° with the horizontal portion.

15. The passenger seat according to claim 12, wherein the second moving mechanism comprises a second guide rail and in that the flap comprises a second lug which extends into the second guide rail.

16. The passenger seat according to claim 12, wherein the second moving mechanism is formed by a self-locking ball joint enabling the flap to be moved over an angle of between 0° and 30°.

17.-18. (canceled)

19. The passenger seat according to claim 1, wherein the first moving mechanism comprises a first plate connected to the support frame so that it can slide relative to the support frame and thus perform a back-and-forth movement relative to the vertical portion.

20. Passenger seat according to claim 19, wherein the first plate comprises a first and a second portion mounted together by a hinge to thus enable the first and second portions to pivot relative to each other during said tilting.

21. The passenger seat according to claim 19, wherein the first guide rail is mounted on the support frame on either side of lateral flanks of the first plate.

22. The passenger seat according to claim 19, wherein the first plate is connected to the support frame by means of a return spring arranged to return the first plate to a horizontal rest position.

23. The passenger seat according to claim 19, wherein the first portion of the first plate is mounted in such a way that it remains substantially horizontal during back-and-forth movement, the second portion of the first plate is mounted in such a way that it can pivot during back-and-forth movement.

24. The passenger seat according to claim 19, wherein the first moving mechanism comprises a second plate rigidly connected to the support frame, the first plate being mounted on the second plate.

25. (canceled)
